(19) United States
(12) Patent Application Publication
(10) Pub. No.: US 2009/0064574 A1
(43) Pub. Date: Mar. 12, 2009

(54) Naturally pure pot for planting

(76) Inventor: Quang Ngoc Nguyen, DakLak Province (VN)

Correspondence Address: DONN K. HARMS;PATENT & TRADEMARK LAW CENTER, SUITE 100, 12702 VIA CORTINA, DEL MAR, CA, 92014, US

(21) Appl. No.: 11/918,461

(22) PCT Filed: Jul. 11, 2006
(86) PCT No.: PCT/VN2006/000002

§ 371 Date: Oct. 11, 2007

(30) Foreign Application Priority Data
Jul. 22, 2005 (VN) 2-2005-00132

(51) Int. Cl. A01G 25/16; A01G 25/00

(52) U.S. Cl. 47/79

(57) ABSTRACT

The useful solution mentions the naturally pure pot for planting, comprises a pot (1), the lower half of which has locating ribs (2) lying vertically, prominent inward and equally distancing from each other; two rows of draining holes (3) lying alternately in vertical direction and lower than the upper end of locating ribs (2); a supporting board (4) with holes placed in the pot, rest on the upper end of locating ribs, prominent as cornice on the inside of the pot (1); a cloth covers the supporting board (4) and is fastened and let down. To water the earth in the pot from the above until the water overflows the draining holes (3). To sow seed or to plant in the pot (1). Due to the fact that the supporting board (4) is covered with a cloth (5) let down into the bottom of the wet pot (1), the water is continuously supplied to the earth above, at the same time, thanks to draining holes (3), air will be continuously supplied to the earth on upper half of the pot, making airy the earth in the pot and then supplied to the plants.

### MENTIONED TECHNICAL SECTOR

The useful solution mentions the naturally pure pot for planting Technical Condition of the Useful Solution

Currently planting pots are usually pots with closed bottom, open bottom (with holes or slits) or pot with holes and slits on surrounding side. Pots with holes or slits are not hygienic because earth and water usually go out. Closed pots are waterlogged making plant root rotten and air insufficient

### TECHNICAL NATURE OF THE USEFUL SOLUTION

The purpose of the useful solution is to recommend naturally pure pot to overcome the above mentioned weak points

To win the set purpose, the naturally pure pot for planting under the useful solution comprises a pot, the lower half of which has locating rids lying vertically, prominent inward and equally distancing from each other; two rows of draining holes, lying alternately in vertical direction and lower than the upper end of locating ribs; a supporting board with holes placed in the pots, rest on the upper end of locating ribs, prominent as cornice on the inside of the pot; cloth covers the supporting board and is fastened and let down in the pot.

### BRIEF DESCRIPTION OF THE FIGURES

FIG. 1/2 is the overall drawing of the outline of naturally pure pot for planting under the useful solution.

FIG. 2/2 is the projection of the pot under the useful solution when looking from the above.

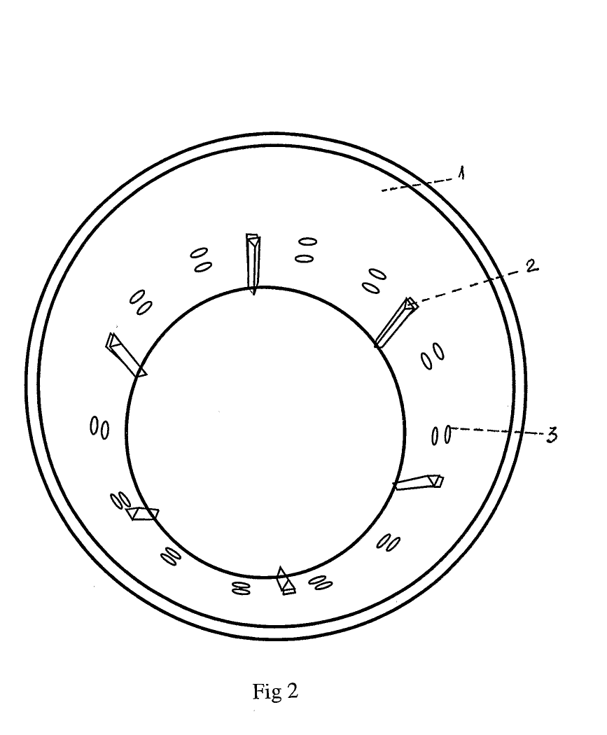

### DETAILED DESCRIPTION OF THE USEFUL SOLUTION

According to the figure, the naturally pure pot for planting under the useful solution comprises a pot (1), the lower half of which has locating ribs (2) lying vertically, prominent inward, equally distancing from each other, two rows of draining holes (3), lying alternately in vertical direction and lower than the upper end of the locating ribs (2); a supporting board (4) with holes placed in the pot (1), rest on the upper end of locating ribs, prominent as cornice on the inside of the pot (1) a cloth covers the supporting board (4) and is fastened and let down in the pot (1)

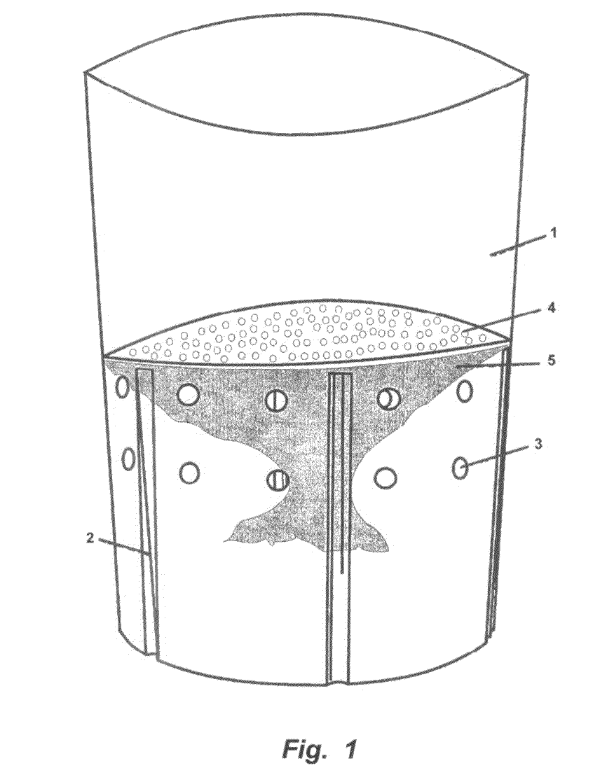

According FIG. 1/1, the earth for planting will be put on the supporting board (4). To water from the above until the water overflows the draining holes (3). To sow seeds or to plant in the earth of the pot. Due to the fact that the supporting board (4) is covered with a cloth let down into the bottom of the wet pot (1), with a cloth let down into the bottom of the wet pot (1), the water is continuously supplied to the earth on the above through a water soaked cloth (5) at the same time, thanks to draining holes (3), air will be continuously supplied to the earth on the upper half of the pot, making airy the earth in the pot and then supplied to the plants.

When the water is insufficient, the care taker actively adds water to the pot (1) and if the water is more than enough that may lead to waterlog, the draining holes (3) will actively take the water to the necessary level in the pot.

1. The naturally pure pot for planting comprises a pot, the lower half of which has locating ribs lying vertically, prominent inward, and equally distancing from each other; two rows of draining holes lying alternately in vertical direction and lower than the upper end of locating ribs; a supporting board with holes placed in the pot rest on the upper end of locating ribs, prominent as cornice on the inside of the pot; a cloth covers the supporting board and is fastened and let down in the pot.
